(19) United States
(12) Patent Application Publication
(10) Pub. No.: US 2026/0298750 A1
(43) Pub. Date: Oct. 1, 2026

(54) SENSOR ARRANGEMENT AND METHOD FOR MANUFACTURING A PLURALITY OF SENSOR ARRANGEMENTS

(71) Applicant: TDK Electronics AG, Muenchen (DE)

(72) Inventors: Christian Wohlgemuth, Berlin (DE); Stefan Kuschel, Stahnsdorf (DE); Thomas Stendel, Rangsdorf (DE); Benjamin Bohl, Berlin (DE); Sven Röhrbein, Berlin (DE)

(21) Appl. No.: 19/475,380

(22) PCT Filed: Mar. 22, 2024
(86) PCT No.: PCT/EP2024/057836

§ 371 Date: Oct. 14, 2025

(30) Foreign Application Priority Data
Apr. 20, 2023 (DE) 10 2023 110 113.7

(51) Int. Cl. G01L 9/06; G01K 7/22; G01L 19/00

(52) U.S. Cl. CPC G01L 9/06; G01K 7/22; G01L 19/0038; G01L 19/0092

(57) ABSTRACT

In an embodiment a sensor arrangement includes a core component including a pressure sensor element, a circuit carrier, and a support element, and an upper housing element surrounding the core component, wherein the upper housing element abuts an upper side of the support element, wherein the circuit carrier has a central region and a peripheral region surrounding the central region, and wherein the support element is arranged in the central region of the circuit carrier and on an upper side of the circuit carrier.

### CROSS-REFERENCE TO RELATED APPLICATIONS

This patent application is a national phase filing under section 371 of PCT/EP2024/057836, filed Mar. 22, 2024, which claims the priority of German patent application no. 102023110113.7, filed Apr. 20, 2023, each of which is incorporated herein by reference in its entirety.

### TECHNICAL FIELD

The present invention relates to a sensor arrangement comprising a pressure sensor element, as well as a method for manufacturing a plurality of sensor arrangements.

### BACKGROUND

Many applications in the fields of industrial and automotive engineering, for example, heat engines, filters, cooling circuits, and air conditioning systems, require simultaneous location-based measurement of the pressure and temperature of a fluid. The sensor arrangements used for this purpose can be exposed to high pressure loads, for example up to 100 bar, as well as high temperatures, for example up to 180 °C, and very low temperatures, down to −40 °C.

### SUMMARY

Embodiments provide an advantageous sensor arrangement.

A sensor arrangement is proposed which comprises a core component and an upper housing element. The core component comprises a pressure sensor element, a circuit carrier and a support element. The upper housing element surrounds the core component. The upper housing element abuts an upper side of the support element. The circuit carrier comprises a central region and a peripheral region that surrounds the central region. The support element is arranged in the central region of the circuit carrier. The support element is arranged on an upper side of the circuit carrier.

The peripheral region of the circuit carrier may be free of the support element. In particular, the support element may comprise a stop surface that abuts a stop surface of the upper housing element. A force exerted on the core component is transmitted to the upper housing element via the stop surface of the support element.

An outer perimeter of the support element may run along a boundary between the peripheral region and the central region of the circuit carrier.

By arranging the support element in the central region of the circuit carrier, force transmission from the core component to the upper housing element can be configured such that the bending moments experienced by the core component are minimized. Therefore, the force can be transmitted via a central region arranged in the center of the circuit carrier, which is sufficiently large to prevent a dome-shaped deformation of the circuit carrier.

Thereby, the bending stresses occurring in the core component can be minimized. A reduction in bending stresses can enable improved miniaturization of the sensor arrangement and increased measurement accuracy. A compact design of the sensor arrangement and low material usage can be achieved.

The upper housing element can be part of a housing for the sensor arrangement. In particular, the upper housing element and a lower housing element, to which the upper housing element can be connected, can form the housing for the sensor arrangement. A fluid, whose pressure is measured by the pressure sensor element, can be conducted to the pressure sensor element via the lower housing element.

Each distance of the support element from an edge point of the circuit carrier can be at least 5%, preferably at least 10% or at least 20% of the length of a straight line connecting the edge point with an opposite edge point of the circuit carrier and passing through the center of the circuit carrier. This arrangement of the support element in the central region of the circuit carrier ensures that the force exerted by the fluid on the core component is transmitted by regions of the core component that are sufficiently far away from the edges of the core component. This prevents bending moments in the plate or circuit carrier caused by forces exerted on the edges.

An outer perimeter of the support element may run along a boundary between the central region and the peripheral region of the circuit carrier. The central region may occupy at least 10% of the area of the circuit carrier, preferably the central region occupies at least 25% of the area of the circuit carrier. This ensures that the support element is sufficiently large to transfer a force to the upper housing element over an area rather than at a single point. Thereby, force peaks can be avoided that could lead to measurement inaccuracies and shorten the service life of the component.

The central region may not occupy more than 80% of the area of the circuit carrier; preferably, the central region occupies less than 60% of the area of the circuit carrier. This ensures that the forces act sufficiently far away from the edge of the circuit carrier so that the circuit carrier does not bend.

The support element may comprise a frame that surrounds an inner region in which the pressure sensor element is located. Since the support element is located on the upper side of the circuit carrier, a force on the upper housing element is not transmitted by the circuit carrier itself or by the pressure sensor element. Instead, the support element is used for this purpose. The support element has a purely mechanical function, so that the elements with a measuring function, circuit carrier and pressure sensor element, are protected against force peaks.

The frame design ensures that force is transmitted to the upper housing element over an area rather than at a single point, so that there is no point-like deformation of the core component.

The support element may comprise a crossbar that runs through an inner region. Alternatively, or additionally, the support element may comprise at least one lug protruding into the inner region. The stop surface of the support element can be formed by the upper sides of the frame, the crossbar, and the at least one lug. The crossbar and the at least one lug thus also contribute to the transmission of force to the upper housing element and additionally distribute the force over a larger area, thereby preventing the occurrence of mechanical stress peaks and the overloading of the materials used.

The sensor arrangement may comprise a lower housing element that forms a media connection channel that is configured to supply a fluid to a lower side of the core component. In particular, the sensor arrangement may be configured such that the fluid is directed to the pressure sensor element, allowing the pressure sensor element to determine the pressure of the fluid.

An axial direction can be defined as the direction along the media connection channel toward the core component. The lower housing element can extend beyond the core component in the axial direction. The lower housing element can comprise a flange that surrounds an axially lower end of the upper housing element. The lower and upper housing elements may be configured such that a force transmitted from the core component to the stop surface of the upper housing element is transferred from the upper housing element to the flange of the lower housing element. Thereby, the force can be diverted away from the core component and bending moments in the core component can be avoided. The core component can be configured to transfer a force to the upper housing element via the support elements, whereby the upper housing element is configured to divert the force absorbed by the core component to the flange of the media feed. For this purpose, the upper housing element is configured to be sufficiently rigid.

The upper housing element may directly abut the flange. The flange may be sealed with a potting.

The pressure sensor element may be a piezoresistive silicon MEMS element. Compared to other pressure sensor elements, such as ceramic pressure sensor elements, piezoresistive silicon MEMS elements are characterized by a smaller design and a lower price. By using the piezoresistive MEMS silicon element, the effective area on which the fluid acts on the pressure sensor element can be designed to be very small, and the forces acting on the core component can thus be kept low. This can also help to reduce the required installation space and the weight of the sensor arrangement.

The piezoresistive silicon MEMS element can be sensitive in a pressure range between 50 mbar and 50 bar. The piezoresistive silicon MEMS element can deliver an output signal of up to 120 mV. Compared to capacitive pressure sensors, the piezoresistive silicon MEMS element can thus cover a larger measuring range and further generate a stronger output signal that is less sensitive to interference.

The piezoresistive silicon MEMS element can be used for both absolute and relative pressure measurement. It can be used at temperatures ranging from −40 °C to +180 °C.

The sensor arrangement may further comprise a temperature sensor element. The temperature sensor element may be an NTC thermistor. The temperature sensor element may be attached to the circuit carrier of the core component.

The core component may comprise a plate arranged on the lower side of the circuit carrier, wherein the pressure sensor element is attached to an upper side of the plate and the plate comprises a channel, wherein the pressure sensor element is arranged at one end of the channel. A fluid can be fed through the plate to the pressure sensor element via the channel. The plate may seal a media connection channel formed by the lower housing element against the circuit carrier. The plate may comprise or consist of a media-resistant material, for example steel, ceramic, glass, or a plastic.

The temperature sensor element may comprise two connecting wires, each of which passes through a feedthrough in the plate, wherein the feedthroughs in the plate are sealed by a potting material. The upper housing element may comprise at least one contact element that is electrically connected to the circuit carrier.

Another aspect relates to a method for manufacturing a plurality of the sensor arrangements described above, wherein the core components are manufactured and calibrated in a panel.

### BRIEF DESCRIPTION OF THE DRAWINGS

Preferred embodiments of the invention are described below with reference to the accompanying figures.

FIG. 1 shows a sensor arrangement for measuring pressure and temperature in an exploded view;

FIG. 2 shows an upper side of a core component;

FIG. 3 shows a lower side of the core component;

FIG. 4 shows a circuit carrier;

FIG. 5 shows a cross-sectional view of an upper housing element;

FIG. 6 shows a cross-sectional view of a lower housing element; and

FIG. 7 shows a force flow in the sensor arrangement.

### DETAILED DESCRIPTION OF ILLUSTRATIVE EMBODIMENTS

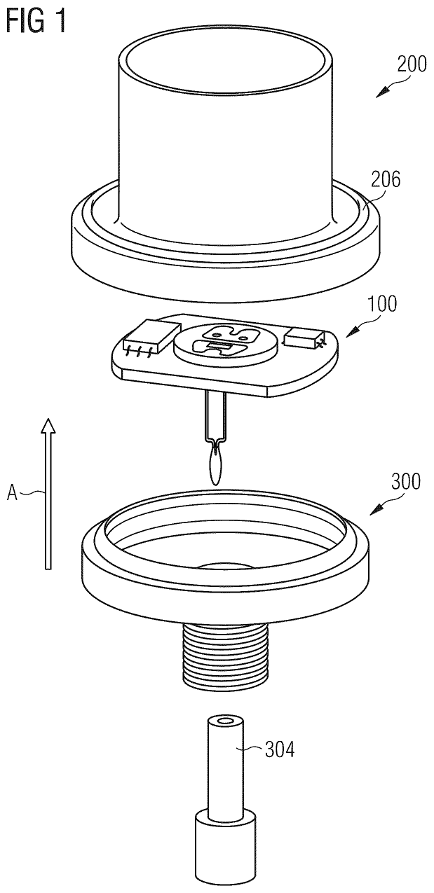

FIG. 1 shows a sensor arrangement for measuring pressure and temperature in an exploded view.

The sensor arrangement comprises a core component 100, an upper housing element 200, and a lower housing element 300.

The core component 100 comprises a pressure sensor element 104 that is configured to determine the absolute or relative pressure of a fluid, i.e., a liquid or a gas. The pressure sensor element 104 is configured to convert the pressure exerted on it into an electrical signal from which the pressure level can be determined. A medium is applied to a rear side of the pressure sensor element 104 facing a media connection channel. The pressure sensor element 104 may comprise a bending plate whose area and thickness are selected with regard to a desired measuring range. The pressure sensor element 104 is a piezoresistive silicon MEMS element.

In the embodiments shown in the figures, the core component 100 further comprises a temperature sensor element 105 that is configured to determine a temperature of the fluid. In an alternative embodiment, the core component does not comprise a temperature sensor element 105. Furthermore, the core component comprises a circuit carrier 102 via which the sensor elements 104, 105 are contacted.

The temperature sensor element 105 is configured to generate an electrical signal whose magnitude depends on the temperature of the fluid. The temperature sensor element 105 may be an NTC thermistor. The temperature sensor element 105 can protrude into the measuring medium in order to detect its temperature with as little distortion as possible and to ensure a response time that is as short as possible.

The lower housing element 300 forms a media connection channel through which the fluid whose pressure and temperature are to be measured can be fed to the sensor elements 104, 105 of the core component 100.

The upper housing element 200 is connected to the lower housing element 300 and surrounds the core component 100, thereby protecting it from environmental influences, wherein a lower side of the core component is not covered by the upper housing element 200. The sensor arrangement is configured such that forces exerted by the fluid on the core component 100 can be transmitted via the upper housing element 200 to the lower housing element 300.

An axial direction A is defined as a direction that runs along the media connection channel and points from a lower side 110 of the core component 100 to an upper side 111 of the core component 100. Hereinafter, elements pointing in the opposite direction to the direction from which the fluid is supplied to the core component 100 are referred to as “at the bottom in the axial direction A.” Hereinafter, elements pointing in the direction in which the fluid is supplied to the core component 100 are referred to as “at the top in the axial direction A.”

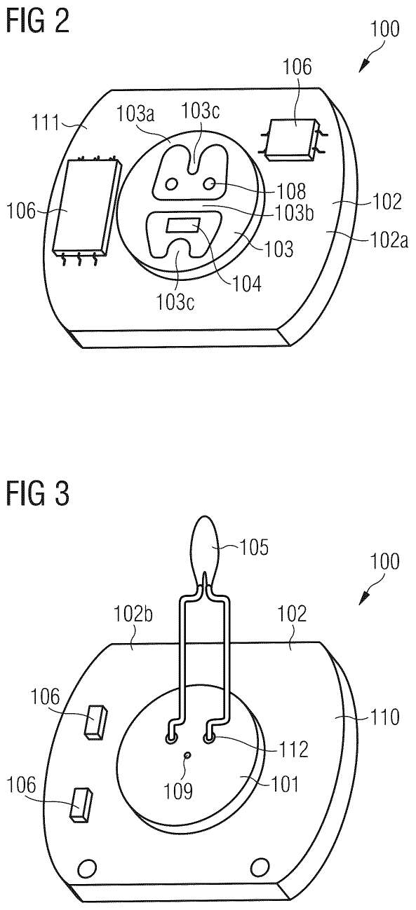

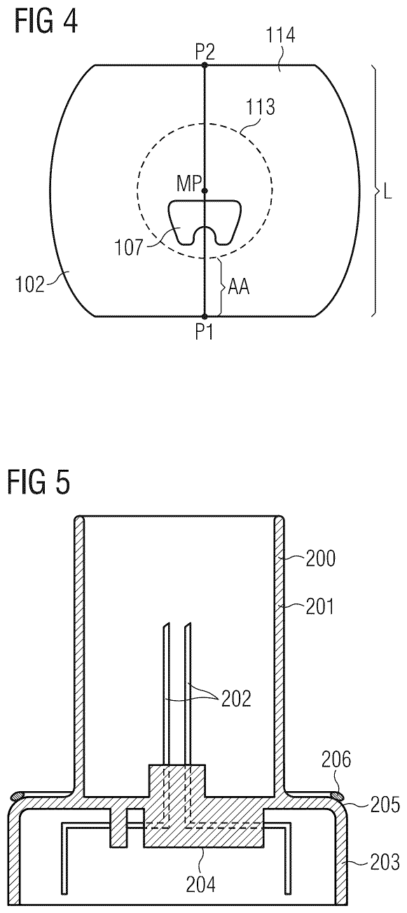

The core component 100 is described below. FIG. 2 shows an upper side 111 of the core component 100. FIG. 3 shows a lower side 110 of the core component 100. FIG. 4 shows the circuit carrier 102 of the core component 100.

The core component 100 comprises the pressure sensor element 104, the temperature sensor element 105, the circuit carrier 102, a support element 103, and a plate 101.

An upper side 102a of the circuit carrier 102 faces away from the media connection channel of the lower housing element 300. A lower side 102b of the circuit carrier 102 faces toward the media connection channel of the lower housing element 300.

The support element 103 and at least one electronic component 106 are arranged on the upper side 102a of the circuit carrier 102. The circuit carrier 102 comprises a recess 107 in which the pressure sensor element 104 is arranged. The recess 107 is an opening that extends in the axial direction A through the circuit carrier and is large enough to accommodate the pressure sensor element 104. The pressure sensor element 104 is connected to the circuit carrier 102 via bonding wires. The bonding wires span the recess 107.

The support element 103 comprises a frame 103a that surrounds the pressure sensor element 104 and the recess 107 of the circuit carrier 102. The support element 103 further comprises a crossbar 103b, which divides an inner region surrounded by the frame 103a into two chambers. The support element 103 comprises two lugs 103c that protrude into the inner region.

The pressure sensor element 104 is arranged in a first of the two chambers formed by the frame 103a and the crossbar 103b. The chamber in which the pressure sensor element 104 is arranged may be filled with a passivation that can cover the pressure sensor element 104.

The support element 103 extends upward in the axial direction from the circuit carrier 102 and forms a stop surface which the upper housing element 200 abuts and via which forces are transmitted to the upper housing element 200. An upper side of the frame 103a, an upper side of the crossbar 103b, and upper sides of the lugs 103c projecting into the inner region abut the upper housing element 200.

Electrical contacts 108 of the temperature sensor element 105 are arranged in a second of the two chambers formed by the frame 103a and the crossbar 103b.

The electronic components 106 arranged on the circuit carrier 102 form a control and evaluation electronics that is connected to the pressure sensor element 104 and the temperature sensor element 105. The circuit carrier 102 comprises a printed circuit board material, for example FR4.

The plate 101 is arranged on the lower side 102b of the circuit carrier 102 and comprises a media-resistant material, for example ceramic, steel, glass, or a plastic. The plate 101 is arranged such that it seals the media connection channel formed by the lower housing element 300 against the circuit carrier 102. The plate 101 comprises a channel 109 through which a fluid can flow from the media connection channel to the pressure sensor element 104. The pressure sensor element 104 is arranged on a side of the channel 109 facing away from the media connection channel.

The plate 101 comprises feedthroughs 112 for connecting wires of the temperature sensor element 105. Once the connecting wires are arranged in the feedthroughs 112, the feedthroughs 112 are closed by a potting material and sealed in this way. Further electronic components 106, which are components of the control and evaluation electronics, may be arranged on the lower side 102b of the circuit carrier 102.

The circuit carrier 102 enables mechanical and electrical connection of the electronic components 106 and the sensor elements 104, 105. Furthermore, the circuit carrier 102 is electrically and mechanically connected to contact elements 202 arranged in the upper housing element 200.

The support element 103 and the plate 101 can each be connected to the circuit carrier 102 by means of an adhesive.

FIG. 4 shows the circuit carrier 102, with a central region 113 and a peripheral region 114 marked. The support element 103 is arranged exclusively in the central region 113. It is not arranged in the peripheral region 114. The peripheral region 114 surrounds the central region 113.

The central region 113 comprises the geometric center of the circuit carrier. The central region 113 comprises at least 10% of the area of the circuit carrier 102, preferably at least 25% of the area of the circuit carrier 102. An outer contour of the central region 113 is defined by the frame 103a formed by the support element 103, wherein the outer edge of the frame 103a forms a boundary between the central region 113 and the peripheral region 114.

Each distance AA of the support element 103 from an edge point P1 of the circuit carrier 102 is at least 5%, preferably 10% or 20%, of a length L of a straight line which connects the edge point P1 with an opposite edge point P2 of the circuit carrier 102 and passes through a center point MP of the circuit carrier 102. The length of the straight line indicates a diameter of the circuit carrier 102. The arrangement described allows the support element 103 to be arranged centrally on the circuit carrier 102 and to comprise a sufficient distance from the edges of the circuit carrier 102.

A force exerted on the core component 100 by the fluid is transmitted to the upper housing element 200 via the support element 103. The arrangement of the support element 103 in the central region 113 of the circuit carrier 102 ensures that the bending moments exerted by the force on the core component 100 are minimized. The force is transmitted by the support element 103 via the central region 113, and thus also via the center point of the core component 100, to the upper housing element 200. Since the central region 113 is used for force transmission, bending of the core component 100 can be avoided, which could occur if the force were transmitted via the peripheral region 114.

Since the central region 113 comprises at least 10%, preferably 25%, of the area of the circuit carrier 102 and is defined by the frame 103a, it is ensured that the force is transmitted over a sufficiently large area and not approximately at a single point, so that the occurrence of a single force peak in the core component 100 is avoided, which could otherwise lead to measurement inaccuracies and/or reduced long-term stability.

The upper housing element 200 is described below. FIG. 5 shows a cross-sectional view of the upper housing element 200.

The upper housing element 200 comprises a plastic element 201 and contact elements 202. The plastic element 201 extends essentially in the axial direction A. In its lower region, the plastic element 201 comprises a collar 203, i.e., a region that comprises a larger cross-section than the other regions of the upper housing element 200.

The collar 203 of the upper housing element 200 comprises sufficient rigidity to divert a force in the axial direction A to a flange 301 of the lower housing element 300, which abuts the collar 203 in the axial direction.

The collar 203 is configured to surround the core component 100 and to extend downwards beyond the core component 100 in the axial direction A. A stop surface 204 is formed inside the collar 203, which the support element 104 of the core component 100 abuts. Forces are transmitted from the support element 104 to the upper housing element 200 via the stop surface 204. The upper housing element 200 is configured to transmit these forces to the flange 301 of the lower housing element 300.

Furthermore, the upper housing element comprises contact elements 202 that are electrically connected to the circuit carrier 102. The contact elements 202 enable electrical contact between the circuit carrier 102 and external electronics. The contact elements 202 are designed as metallic, spring contact pins. They are configured to be inserted into contact connections of the circuit carrier 102 and thus position the core component 100 during assembly.

Each of the contact elements 202 comprises two bends, wherein the contact elements 202 run parallel to each other at a small distance in an upper region of the upper housing element 200 in the axial direction A and are arranged further apart from each other in the collar 203 of the upper housing element 200. The two bends cause the contact elements 202 to be spring-loaded. The plastic part 201 comprises guide elements that define the course of the contact elements 202 and comprise a recess, thus enabling the contact elements 202 to be spring-loaded. This allows manufacturing tolerances to be compensated for.

A potting 206 is also applied to an outer surface 205 of the collar 203, which abuts the flange 301 of the lower housing element 300, connecting and sealing the upper housing element 200 and the lower housing element 300. The potting 206 seals the interior of the upper housing element 200 and the lower housing element 300 against environmental influences. Furthermore, the potting 206 provides mechanical stabilization of the connection between the housing elements 200, 300. The potting 206 may comprise a sealing compound that compensates for differences in the coefficients of expansion of the upper and lower housing elements 200, 300. Thereby, the development of mechanical stresses can be reduced or avoided, ensuring a long-term stable seal between the flange and the collar.

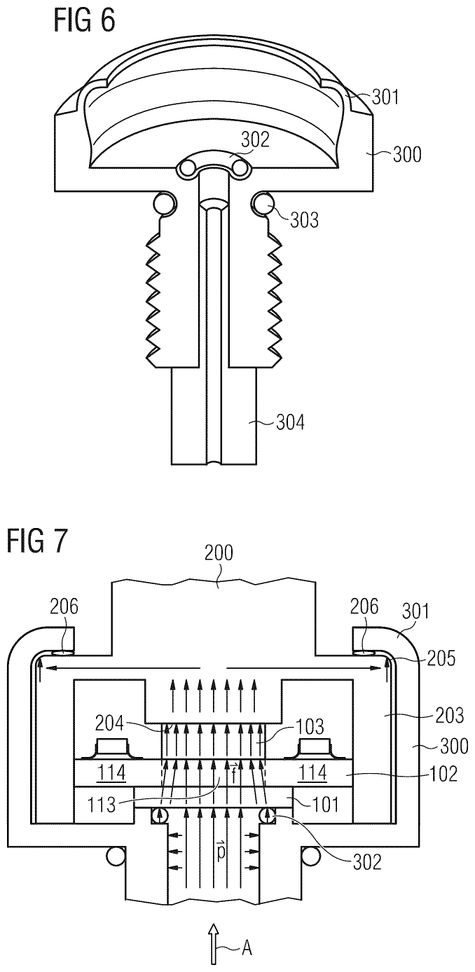

FIG. 6 shows a cross-sectional view of the lower housing element 300.

The lower housing element 300 is configured to be connected to the upper housing element 200. The lower housing element 300 comprises a first sealing ring 302 located on the inside and may further comprise a second sealing ring 303 located on the outside of the lower housing element. The lower housing element may further comprise a nozzle-shaped protective element 304.

The lower housing element 300 comprises an upper region with a large cross-section, which is configured to surround the core component 100 and further to surround the collar 203 of the upper housing element 200. The upper region comprises an inward-facing flange 301 at its upper end. This abuts either directly or via the potting 206 the outer surface 205 of the collar 203 of the upper housing element 200.

The first inner sealing ring 302 seals the media connection channel against the plate 101. The inner sealing ring 302 forms an axial seal with the lower housing element 300 and the plate 101.

A lower region of the lower housing element 300 comprises a smaller diameter than the upper region. The lower region is tubular in design and hollow inside. The inside of the lower region forms the media connection channel through which a fluid is fed to the core component 100. The outer wall of the lower region may be designed as a thread. The second sealing ring 303 may be arranged on the outside of the lower housing element 300 in the transition from the lower region to the upper region. It is configured to seal the lower housing element 300 when the sensor arrangement is installed. Alternative designs of the sealing region of the lower housing element 300 are possible.

The protective element 304 can be configured such that it surrounds the temperature sensor element 105 and thus protects it mechanically. At the same time, it must allow good access of the measuring medium to the temperature sensor element 105.

Furthermore, the protective element 304 can electrically and thermally insulate the temperature sensor element 105 from the lower housing element 300, thereby increasing the measuring accuracy.

The protective element 304 may be a plastic part, which can be fixed in the lower housing element 300 by means of a form fit. Since the protective element 304 is not attached to the core component 100, no mechanical stress is exerted on the core component 100 by the protective element 304. A bi-directional form fit between the protective element 304 and the lower region of the lower housing element 300 ensures that the protective element 304 is held in the lower housing element 300. The form fit can be formed, for example, by a deformation, such as heat staking. In an alternative embodiment, the sensor arrangement may not comprise a protective element 304.

FIG. 7 shows the flow of force in the sensor arrangement. The flow of force is outlined by arrows. The illustration is intended to show only the basic force distribution. The length and density of the arrows do not allow any conclusions to be drawn about the magnitude of the respective forces acting.

In the media connection channel formed in the lower housing element 300, the arrows indicate a pressure p that acts in both the radial and axial directions. In the core component 100 and in the upper housing element 200, the arrows indicate a force f.

The fluid flowing through the media connection exerts a force in the axial direction A upward on the core component 100 with its pressure. This force is first exerted on the plate 101, which seals the media connection channel. The force is transmitted to the support element 103 via the plate 101 and the circuit carrier 102. The support element 103 forms a stop surface that abuts the stop surface 204 of the upper housing element 200, so that the force is transmitted from the support element 103 to the upper housing element 200. The upper housing element 200 is now configured such that the force is transmitted to the flange 301 of the lower housing element 300 that the collar 203 of the upper housing element 200 abuts in the axial direction.

In the circuit carrier 102, the force acts in the central region 113. The force does not act on the peripheral region 114 of the circuit carrier 102. Since the support element 103 is arranged in the central region 113 of the circuit carrier 102 and abuts the stop surface 204 of the upper housing element 200, the support element 103 absorbs the force and transmits it to the upper housing element 200. This prevents the circuit carrier 102 from bending. Supports in the peripheral region 114 of the circuit carrier 102 are not necessary. The peripheral region 114 of the circuit carrier 102 can be used for the electronic components.

The core component is manufactured and calibrated in a panel. This improves the manufacturing process and, in particular, makes it more cost-effective.

1.-17. (canceled)

18. A sensor arrangement comprising:
a core component comprising a pressure sensor element, a circuit carrier, and a support element; and
an upper housing element surrounding the core component,
wherein the upper housing element abuts an upper side of the support element,
wherein the circuit carrier comprises a central region and a peripheral region surrounding the central region, and
wherein the support element is arranged in the central region of the circuit carrier and on an upper side of the circuit carrier.

19. The sensor arrangement according to claim 18, wherein each distance of the support element from an edge point of the circuit carrier is at least 5% of a length of a straight line connecting the edge point with an opposite edge point of the circuit carrier and passes through a center point of the circuit carrier.

20. The sensor arrangement according to claim 18,
wherein an outer perimeter of the support element runs along a boundary between the central region and the peripheral region of the circuit carrier, and
wherein the central region occupies at least 10% of an area of the circuit carrier.

21. The sensor arrangement according to claim 18, wherein the support element comprises a frame surrounding an inner region in which the pressure sensor element is arranged.

22. The sensor arrangement according to claim 21,
wherein the support element comprises a crossbar extending through the inner region, and/or
wherein the support element comprises at least one lug projecting into the inner region.

23. The sensor arrangement according to claim 18, further comprising:
a lower housing element, which forms a media connection channel, and which is configured to supply a fluid to a lower side of the core component.

24. The sensor arrangement according to claim 23,
wherein an axial direction points along the media connection channel toward the core component,
wherein the lower housing element extends beyond the core component in the axial direction, and
wherein the lower housing element comprises a flange surrounding a lower end of the upper housing element in the axial direction.

25. The sensor arrangement according to claim 24,
wherein the core component is configured to transmit a force to the upper housing element via the support element, and
wherein the upper housing element is configured to transmit the force received by the core component to the flange of the lower housing element.

26. The sensor arrangement according to claim 23, wherein the upper side of the circuit carrier faces away from the media connection channel.

27. The sensor arrangement according to claim 24, wherein the upper housing element comprises a collar at the lower end in an axial direction, which abuts an inside of the flange of the lower housing element.

28. The sensor arrangement according to claim 24, wherein the upper housing element and the flange are connected to each other and sealed to each other by a potting.

29. The sensor arrangement according to claim 18, wherein the pressure sensor element is a piezoresistive silicon MEMS element.

30. The sensor arrangement according to claim 18, further comprising a temperature sensor element.

31. The sensor arrangement according to claim 30,
wherein the core component comprises a plate arranged on the lower side of the circuit carrier,
wherein the pressure sensor element is attached to an upper side of the plate,
wherein the plate comprises a channel and the pressure sensor element is arranged at one end of the channel,
wherein the temperature sensor element comprises two connecting wires, each of which passes through a feedthrough in the plate, and
wherein the feedthroughs in the plate are sealed by a potting material.

32. The sensor arrangement according to claim 18,
wherein the core component comprises a plate arranged on the lower side of the circuit carrier,
wherein the pressure sensor element is attached to an upper side of the plate, and
wherein the plate comprises a channel and the pressure sensor element is arranged at one end of the channel.

33. The sensor arrangement according to claim 32, wherein the plate comprises steel, ceramic, glass, or plastic.

34. The sensor arrangement according to claim 18, wherein the support element is configured to transmit a force exerted on the core component by a fluid to the upper housing element via the support element.

35. A method for manufacturing a plurality of sensor arrangement according to claim 18,
wherein the core components are manufactured and calibrated in a panel.
